(19) United States
(12) Patent Application Publication
(10) Pub. No.: US 2025/0321773 A1
(43) Pub. Date: Oct. 16, 2025

(54) DATA ACCESS METHOD BASED ON DEVICE PASSTHROUGH OF VIRTUAL MACHINE, DEVICE AND SYSTEM

(71) Applicant: CLOUD INTELLIGENCE ASSETS HOLDING (SINGAPORE) PRIVATE LIMITED, Singapore (SG)

(72) Inventors: Yisheng XIE, Hangzhou, Zhejiang (CN); Naixuan GUAN, Hangzhou, Zhejiang (CN); Zhen REN, Beijing (CN)

(21) Appl. No.: 18/864,864

(22) PCT Filed: May 11, 2023
(86) PCT No.: PCT/CN2023/093407

§ 371 Date: Nov. 11, 2024

(30) Foreign Application Priority Data
May 19, 2022 (CN) 202210557053.8

(51) Int. Cl. G06F 9/455

(52) U.S. Cl. CPC G06F 9/45558; G06F 2009/45579; G06F 2009/45583

(57) ABSTRACT

The present application provides a data access method based on device passthrough of a virtual machine, a device and a system. The method includes the following steps. A peripheral device receives, through a first VF in a VF set, a data access request sent by a virtual machine, where the data access request is used for requesting the peripheral device to perform data access to target data in a memory space corresponding to a first data access address; determines at least one second VF for performing data access from the VF set according to a data access volume of the target data; and performs data access to the target data in the memory space corresponding to the first data access address through the at least one second VF, where the VF set of the peripheral device is device passthrough with the virtual machine in the host machine, and the VF set is passthrough into a virtual device in the virtual machine of the host machine, so as to reduce the complexity of data processing of the virtual machine, and then reduce the processor overhead of the host machine.

### CROSS-REFERENCE TO RELATED APPLICATIONS

This application is a National Stage of International Application No. PCT/CN2023/093407, filed on May 11, 2023, which claims priority to Chinese Patent Application No. 202210557053.8, filed to China National Intellectual Property Administration on May 19, 2022 and entitled “DATA ACCESS METHOD BASED ON DEVICE PASSTHROUGH OF VIRTUAL MACHINE, DEVICE AND SYSTEM”. The afore-mentioned applications are hereby incorporated by reference in their entireties.

### TECHNICAL FIELD

The present application relates to the field of cloud computing technologies and, in particular, to a data access method based on device passthrough of a virtual machine, a device and a system.

### BACKGROUND

In some cloud service scenarios, based on SR-IOV technology, one Physical Function (PF) of a peripheral device can generate multiple Virtual Functions (VFs), and a virtual device corresponding to each VF in the peripheral device can be device passthrough with a virtual machine of a host machine. When the peripheral device performs data access to the virtual machine through the virtual device, it is necessary for the host machine to allocate bandwidth through the virtual machine to determine the virtual device in the peripheral device that can perform data access to the virtual machine. In this case, the data processing of the virtual machine is complicated, which leads to a large processor overhead of the host machine.

### SUMMARY

Embodiments of the present application provide a data access method based on device passthrough of a virtual machine, a device and a system, so as to reduce the complexity of data processing of the virtual machine and further reduce the processor overhead of the host machine.

In a first aspect, the embodiments of the present application provide a data access method based on device passthrough of a virtual machine, which is applied to a peripheral device, where a VF set in the peripheral device is device passthrough with a virtual machine device in a host machine, the VF set is passthrough into a virtual device in the virtual machine of the host machine, and the method includes: receiving, through a first VF in the VF set, a data access request sent by the virtual machine, where the data access request is used for requesting the peripheral device to perform data access to target data in a memory space corresponding to a first data access address; determining at least one second VF for performing data access from the VF set according to a data access volume of the target data; and performing data access to the target data in the memory space corresponding to the first data access address through the at least one second VF.

In a second aspect, the embodiments of the present application provide a data access method based on device passthrough of a virtual machine, which is applied to a host machine, where a virtual machine in the host machine is device passthrough with a VF set in a peripheral device, the VF set is passthrough into a virtual device in the virtual machine of the host machine, and the method includes: determining a first data access address of target data; and sending a data access request to a first VF in the VF set through the virtual machine, where the data access request is used for requesting the peripheral device to perform data access to the target data in a memory space corresponding to the first data access address.

In a third aspect, the embodiments of the present application provide a peripheral device, where a VF set in the peripheral device is device passthrough with a virtual machine in a host machine, the VF set is passthrough into a virtual device in the virtual machine of the host machine, and the peripheral device includes: a transceiver unit, configured to receive a data access request sent by the virtual machine through a first VF in the VF set, where the data access request is used for requesting the peripheral device to perform data access to target data in a memory space corresponding to a first data access address; a processing unit, configured to determine at least one second VF for performing data access from the VF set according to a data access volume of the target data; and a data access unit, configured to perform data access to the target data in the memory space corresponding to the first data access address through the at least one second VF.

In a fourth aspect, the embodiments of the present application provide a host machine, where a virtual machine in the host machine is device passthrough with a VF set in a peripheral device, the VF set is passthrough into a virtual device in the virtual machine of the host machine, and the host machine includes: a processing unit, configured to determine a first data access address of target data; and a transceiver unit, configured to send a data access request to a first VF in the VF set through the virtual machine, where the data access request is used for requesting the peripheral device to perform data access to the target data in the memory space corresponding to the first data access address.

In a fifth aspect, the embodiments of the present application provide an electronic device, including at least one processor and a memory; where the memory stores computer-executable instructions; and the at least one processor executes the computer-executable instructions stored in the memory, so that the at least one processor performs the method as provided in the first aspect or the second aspect.

In a sixth aspect, the embodiments of the present application provide a device passthrough system, which includes a peripheral device and a host machine; where a VF set in the peripheral device is device passthrough with a virtual machine of the host machine, and the VF set is passthrough into a virtual device in the virtual machine of the host machine; the host machine is configured to send a data access request to a first VF in the VF set through the virtual machine, and the data access request is used for requesting the peripheral device to perform data access to target data in a memory space corresponding to a first data access address; the peripheral device is configured to receive, through the first VF in the VF set, the data access request sent by the virtual machine.

In a seventh aspect, the embodiments of the present application provide a computer-readable storage medium, in which computer-executable instructions are stored, and when the computer-executable instructions are executed by a processor, the method as provided in the first aspect or the second aspect is implemented.

In an eighth aspect, the embodiments of the present application provide a computer program product including computer instructions, when the computer instructions are executed by a processor, the method provided in the first aspect or the second aspect is implemented.

In the embodiments of the present application, a VF set is device passthrough with a virtual machine (VM) in a host machine, and the VF set is passthrough into a virtual device in the virtual machine, and the virtual device performs information interaction with the virtual machine on a control plane through a first VF in the VF set, thus avoiding the information interaction on the control plane between the virtual machine and a plurality of VFs, and simplifying the processing process of the virtual machine. In addition, the peripheral device determines at least one second VF for data access from the VF set, thus avoiding bandwidth allocation at the virtual machine side, reducing the complexity of data processing of the virtual machine and the processor overhead of the host machine.

### BRIEF DESCRIPTION OF DRAWINGS

FIG. 1 illustrates a schematic diagram of a scenario 100 of device passthrough of a virtual machine (VM) according to an embodiment of the present application.

FIG. 2 is a schematic diagram of a device passthrough system 200 according to an embodiment of the present application.

FIG. 3 is an interactive flow schematic diagram of a data access method 300 based on device passthrough of a virtual machine according to an embodiment of the present application.

FIG. 4 is a schematic block diagram of an apparatus 400 according to an embodiment of the present application.

FIG. 5 a schematic structural diagram of an electronic device 500 according to an embodiment of the present application.

FIG. 6 a schematic structural diagram of a cloud server 600 according to an exemplary embodiment of the present application.

### DESCRIPTION OF EMBODIMENTS

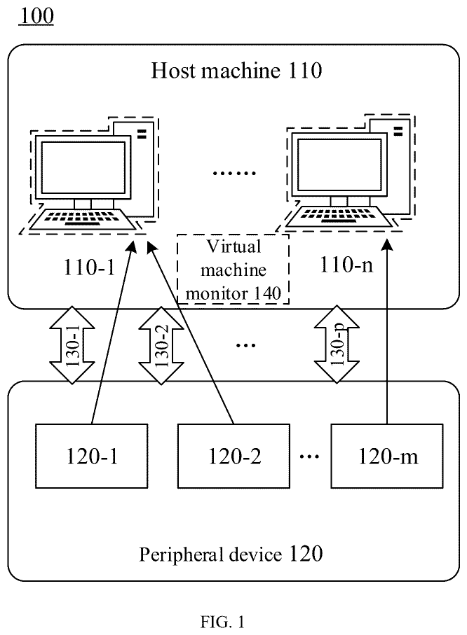

FIG. 1 illustrates a schematic diagram of a scenario 100 of device passthrough of a Virtual Machine (VM) according to an embodiment of the present application.

As shown in FIG. 1, the host machine 110 can be an implementation of a cloud server side, for example, it can be a server in a cloud or a server in a cloud server cluster. The host machine 110 provides for cloud services a carrier of remote services, and the cloud services exist on a server in the form of virtual machines 110-1 to 110-n.

The peripheral device 120 is an auxiliary device in a computer system that connects with a host, and can be simply referred to as a peripheral. For example, it can be a network card, a disk, and other devices that may be connected to the host, such as a mouse, a keyboard, a printer, a projector, a speaker, a camera.

In an implementation, the peripheral device 120 may be a device meeting the

Peripheral Component Interconnect Express (PCIe) protocol, and a device meeting the PCIe protocol may be called a PCIe device.

There are a plurality of VFs in the peripheral device 120, such as 120-1 to 120-m in FIG. 1. Exemplarily, the peripheral device 120 can generate a plurality of VFs through a PF based on Single Root I/O Virtualization (SR-IOV) technology.

The above-mentioned virtual machines 110-1 to 110-n in the host machine 110 can be device passthrough (or virtualization passthrough) with the VFs in the peripheral device 120, respectively, so that the VFs in the peripheral device 120 can directly perform data access to a virtual machine in the host machine 110 without going through the Virtual Machine Monitor (VMM) (or hypervisor) 140.

When the virtual machines 110-1 to 110-n in the host machine 110 is device passthrough with the VFs in the peripheral device 120, data access can be realized between the host machine 110 and the peripheral device 120 through a passthrough channel. In a Multi-Host scenario, data access can be realized between the host machine 110 and the peripheral device 120 through multiple passthrough channels (such as 130-1 to 130-p in FIG. 1).

Generally speaking, a VF in the peripheral device 120 accesses a memory mapped by the virtual machine in the host machine 110 through a passthrough channel to realize data access.

When the peripheral device 120 is a PCIe device, data access is performed between the peripheral device 120 and the host machine 110 through the PCIe channels 130-1 to 130-p. Generally speaking, the number of the PCIe channels 130-1 to 130-p may be the same as that of VF 120-1 to 120-m, or the number of the PCIe channels 130-1 to 130-p may be less than that of VF 120-1 to 120-m.

The embodiments of the present application only take a peripheral device 120 meeting the PCIe protocol as an example to explain, but it does not constitute any limitation to the present application. For example, the peripheral device 120 can also be a device meeting the PCI protocol, and when the peripheral device 120 is a device meeting the PCI protocol, data access is performed between the peripheral device 120 and the host machine 110 through the PCI channels 130-1 to 130-p.

VMM 140 can be used to build and execute one or more VMs, which can be implemented as at least one of software, firmware or hardware. Generally speaking, the VMM 140 can be deployed in the host machine 110. Of course, the embodiments of the present application does not exclude other deployment modes of the VMM 140. For example, the VMM 140 can be deployed independently of the host machine 110.

At present, the virtualization scenario mainly includes the following two device passthrough schemes.

Scheme 1, the PF of the peripheral device 120 is completely passthrough to a virtual machine in the host machine 110.

Scheme 2, the peripheral device 120 is based on SR-IOV technology, and one PF will generate multiple VFs, and each VF is passthrough to a virtual machine in the host machine 110. For example, VF 120-1 and VF 120-2 are passthrough to the virtual machine 110-1, and VF 120-n is passthrough to the virtual machine 110-n. It should be noted that a VF is an independent peripheral device for a virtual machine.

Taking the peripheral device 120 implemented as a network card as an example, VF 120-1 and VF 120-2 are two network cards for the virtual machine 110-1. When the virtual machine 110-1 needs to send data to a network (such as the Internet or a local area network), it can inform VF 120-1 and/or VF 120-2 to access the corresponding memory address of the virtual machine 110-1 in the host machine 110, read the data, and send the read data to the network through VF 120-1 and/or VF 120-2. When the virtual machine 110-1 needs to receive data from the network, it can inform the VF 120-1 and/or VF 120-2 to access the corresponding memory address of the virtual machine 110-1 in the host machine 110 and write the data obtained in the network.

In the above scheme 2, the virtual machine 110-1 is passthrough with more than one VF, and it can be determined based on which VF or VFs to realize data access based on the device capability of the virtual device that each VF is passthrough. For example, if the peripheral device 120 is implemented as a network card, and a virtual network card 1 and a virtual network card 2 in the peripheral device 120 are both passthrough with the virtual machine 120-1 in the host machine 110, when the virtual machine needs to interact data with the network, it needs to determine the virtual network card for data access based on the respective bandwidths of the virtual network card 1 and the virtual network card 2, that is, the virtual machine needs to realize data interaction with the network through the data access of corresponding virtual network card after allocating bandwidths for virtual network cards. In this case, the data processing process of the host machine is complicated, which leads to a large processor overhead of the host machine.

In order to solve the above technical problem, the embodiments of the present application introduce a VF set into the peripheral device. On the one hand, the VF set is device passthrough with the virtual machine (VM) in the host machine, where the VF set is passthrough into a virtual device in the virtual machine, and the virtual device interacts information with the virtual machine on the control plane through one VF in the VF set (such as the first VF in the following), thus avoiding the information interaction on the control plane between the virtual machine and a plurality of VFs and simplifying the processing process of the virtual machine. On the other hand, the peripheral device determines the VF (such as the at least one second VF in the following) for data access from the VF set, thus avoiding bandwidth allocation at the virtual machine side, reducing the complexity of data processing of the virtual machine and the processor overhead of the host machine.

The n, m and p in the above text are all positive integers.

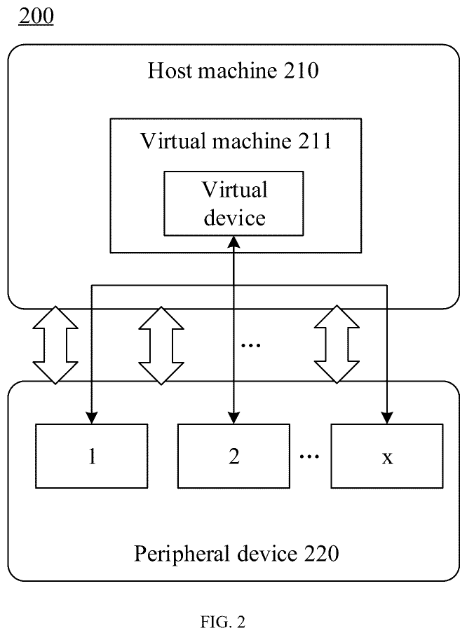

FIG. 2 is a schematic diagram of a device passthrough system 200 according to an embodiment of the present application. As shown in FIG. 2, the system 200 includes a host machine 210 and a peripheral device 220. The virtual machine 211 in the host machine 210 is device passthrough with the VF set in the peripheral device 220, and the VF set generally includes a plurality of VFs (including VFs 1-x in FIG. 2, for example). Of course, the present application does not exclude the possibility that the VF set includes one VF. As shown in FIG. 2, for the virtual machine in the host machine, the VF set is passthrough into a virtual device. For example, the whole device information of the VF set (such as group identification, PCI information, register information, bandwidth, etc.) can be viewed in the virtual machine. Or, for the virtual machine in the host machine, the VF set is one of the VFs (i.e. the first VF). For example, device information such as the identification of the first VF, PCI information, register information and bandwidth of the VF set can be viewed in the virtual machine.

The data access method based on device passthrough of a virtual machine provided by the embodiment of the present application can be applied to the above system shown in FIG. 2.

The data access method based on device passthrough of a virtual machine provided by the embodiment of the present application will be described in detail with the accompanying drawings.

It should be understood that the following is only for the convenience of understanding and explanation, and the method provided by the embodiment of the present application is described in detail by taking the interaction between the peripheral device and the host machine as an example. The peripheral device may be the peripheral device 120 shown in FIG. 1, and the host machine may be, for example, the host machine 110 in FIG. 1.

However, it should be understood that this should not constitute any restrictions on the execution subject of the method provided in the present application. As long as the method provided by the embodiment of the present application can be realized by running a program recording the codes of the method provided by the embodiment of the present application, it can be used as the execution subject of the method provided by the embodiment of the present application. For example, the peripheral device shown in the following embodiment can be replaced by a component in the peripheral device, such as a chips, a chip system or other functional modules capable of calling and executing a program, and the host machine can be replaced by a component in the host machine, such as a chip, a chip system or other functional modules capable of calling and executing a program.

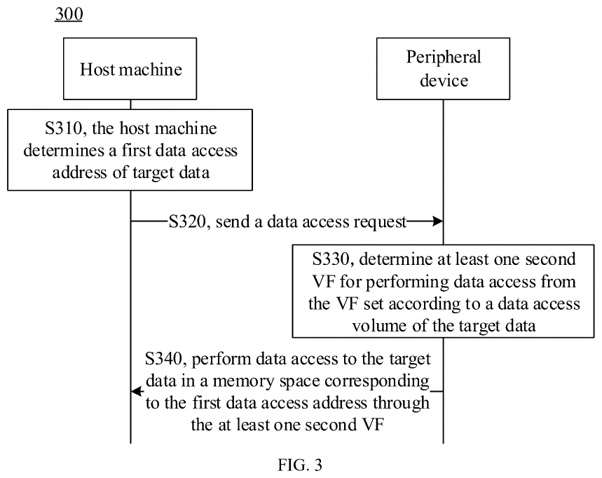

FIG. 3 is an interactive flow schematic diagram of a data access method 300 based on device passthrough of a virtual machine according to an embodiment of the present application. As shown in FIG. 3, the method 300 includes some or all of the following processes:
S310, the host machine determines a first data access address of target data;
S320, the host machine sends a data access request to a first VF in a VF set through a virtual machine; accordingly, the peripheral device receives the data access request sent by the virtual machine through the first VF in the VF set;
S330, the peripheral device determines at least one second VF for performing data access from the VF set according to a data access volume of the target data;
S340, the peripheral device performs data access to the target data in a memory space corresponding to the first data access address through the at least one second VF.

The target data is the data to be accessed. Taking the peripheral device being a network card as an example, the target data can be data sent by the virtual machine to the network, or the target data can be data sent by the network to the virtual machine. The data interaction between the virtual machine and the network can be the data interaction between the virtual machine and other devices (or virtual machines) in the network.

The virtual machine has a corresponding section of memory space in the memory of the host machine, and the first data access address may correspond to the memory space of the virtual machine or a part of the memory space of the virtual machine. Still taking the peripheral device being a network card as an example, when the target data is data sent by the virtual machine to the network, the target data is stored in the memory space corresponding to the first data access address; when the target data is data sent by the network to the virtual machine, the memory space corresponding to the first data access address is used for writing the target data.

It should be noted that the first VF can be any VF in the VF set. For example, the VF set in FIG. 3 that is device passthrough with the virtual machine (VM) may include VFs 1-x. For example, the host machine can randomly designate a VF from the VF set as the first VF through the virtual machine monitor. The first VF can be used for simulating the control plane function of the peripheral device.

In the above S320, the host machine can send a data access request to the first VF through the virtual machine, or send a data access request to the VF set. No matter whether the host machine sends a data access request to the first VF or sends a data access request to the VF set, the peripheral device can receive the data access request through the first VF.

It should be noted that the data access request is used for requesting the peripheral device to perform data access to the target data in the memory space corresponding to the first data access address. In an implementation, the data access request carries the first data access address, or the first data access address can be sent to the peripheral device separately.

In some embodiments, the virtual machine in the host machine can perform data interaction with the first VF in the peripheral device to obtain the data access capability of the VF set. Exemplarily, the host machine can obtain through the virtual machine the device information sent by the first VF, and determine the data access capability of the VF set according to the device information. The device information may include the identification of the first VF/VF set, PCI information of the VF set, register information of the VF set, bandwidth of the VF set, etc. as listed above. The bandwidth of the VF set may be, for example, the sum of the bandwidths of the VFs in the VF set.

After receiving the data access request, the peripheral device needs to determine at least one second VF in the VF set for performing data access. The at least one second VF may not include the first VF, for example, when the VF set includes VF 120-1 and VF 120-2 and the first VF is 120-1, the at least one second VF is 120-2; or at least one second VF may include THE first VF, for example, the first VF is 120-1 in the VF set, and at least one second VF includes VF 120-1 and VF 120-2.

The peripheral device determines at least one second VF from the VF set, where the determining the at least one second VF may be based on the data access volume of the target data. As mentioned above, the data access between the VF and the virtual machine is performed through a passthrough channel, and each passthrough channel has a certain bandwidth limit. If the data volume of the target data exceeds the bandwidth of one passthrough channel, the data access can be performed through more passthrough channels, that is, the number of the passthrough channel can be determined according to the data volume of target data, and accordingly, each VF corresponds to one passthrough channel. If the peripheral device determines that data access needs to be realized through two passthrough channels, it is necessary to determine two second VFs from the VF set.

In an implementation, the data access volume of the target data may be carried in the data access request, or may be determined by the peripheral device based on the data received from the network.

Exemplarily, each VF can be passthrough with multiple virtual machines, so the peripheral device needs to consider whether the VF is used for data access of other virtual machines when determining the second VF from the VF set, and determine the remaining data load volume of the VF when the VF is also used for data access of other virtual machines. Therefore, the peripheral device needs to determine the second VF based on the load volume of each VF in the VF set. In other words, the peripheral device can determine the second VF from the VF set based on a load balancing algorithm.

Exemplarily, the peripheral device can determine at least one second VF from the VF set in combination with the data access volume of the target data and the data load volume of each VF in the VF set. For example, if the data access volume is large, and two second VFs are required to realize data access, but only one second VF can be determined from the VF set based on the load balancing algorithm, it is possible for the peripheral device to perform data access through this second VF.

Exemplarily, the peripheral device can determine, through a device firmware, at least one second VF for performing data access from the VF set.

Furthermore, the peripheral device performs data access to the target data in the memory space corresponding to the first data access address through the determined at least one second VF. Assuming that the peripheral device is implemented as a network card, the peripheral device can read the target data from the memory space corresponding to the first data access address through at least one second VF and send the target data to the network, or the peripheral device can receive the target data from the network through the at least one second VF and write the target data into the memory space corresponding to the first data access address, so as to realize data access.

Assuming that the peripheral device is implemented as a network card, the virtual machine can release the memory space corresponding to the first data access address after the peripheral device reads the target data from the memory space corresponding to the first data access address through the second VF; and when the peripheral device receives the target data from the network through the at least one second VF and writes the target data into the memory space corresponding to the first data access address, the virtual machine can perform packet receiving processing on the target data. Of course, the embodiment of the present application mainly realizes the data access process to the target data, and the purpose of the target data is not limited.

In some embodiments, the above S340 can be implemented as follows. The peripheral device determines at least one second data access address respectively corresponding to the at least one second VF according to the first data access address, where each second data access address corresponds to a different memory space, and the memory space corresponding to each second data access address is included in the memory space corresponding to the first data access address. Further, the peripheral device performs data access to the target data in the memory space corresponding to each second data access address through the at least one second VF, respectively. Based on this, the at least one second VF can implement data access in the memory space corresponding to each second data access address in parallel, thus increasing the bandwidth.

In some embodiments, the second data access address may be a Guest Physical Address (GPA), and the host machine needs to convert each second data access address from a GPA to a Host Physical Address (HPA) in the process of data access that the peripheral device performs based on each second data access address through the at least one second VF. Furthermore, the peripheral device finds the memory space of the corresponding virtual machine in the host machine through the second data access address subjected to address conversion, so as to realize data access through each second VF. Exemplarily, for a second VF among the at least one second VF, the host machine can map the second data access address of the second VF from a GPA to a HPA according to a device page table of the second VF. The device page table is used to represent the mapping relationship between the GPA and the HPA.

It should be noted that each VF in the VF set corresponds to a device page table. In the embodiment of the present application, the device page table corresponding to each VF in the VF set may be the same. The host machine can create the device page table of each VF in the VF set through a VMM (for example, the VMM 140 in FIG. 1), or, the host machine can create the device page table of the first VF through the VMM, and create the same device page table as the first VF for other VFs in the VF set.

In some embodiments, the specific implementation of the above S340 may further include the following. The peripheral device receives an interrupt request sent by any one or more of the at least one second VF, and interrupts the data access of the second VF in response to the interrupt request. The interrupt request carries an interrupt identification, and the host machine can determine a virtual machine identification in an interrupt mapping table of the second VF based on the interrupt identification, so as to control the virtual machine corresponding to the virtual machine identification to interrupt data access. The interrupt mapping table is used to represent the mapping relationship between the interrupt identification and the virtual machine. The interrupt identification can be pre-configured by the host machine for the VF, and each VF can have multiple types of interrupt requests, with each type of interrupt request corresponding to one interrupt identification.

It should be noted that each VF in the VF set corresponds to an interrupt mapping table. In the embodiment of the present application, the interrupt mapping table corresponding to each VF in the VF set is the same. The host machine can create an interrupt mapping table for each VF in the VF set through a VMM (for example, the VMM 140 in FIG. 1), or, the host machine can create an interrupt mapping table for the first VF through the VMM and create the same interrupt mapping table as the first VF for other VFs in the VF set.

Therefore, in the embodiment of the present application, the VF set is device passthrough with the virtual machine (VM) in the host machine, and the VF set is passthrough into a virtual device in the virtual machine, and the virtual device performs information interaction with the virtual machine on the control plane through the first VF in the VF set, thus avoiding the information interaction on the control plane between the virtual machine and a plurality of VFs, and simplifying the processing process of the virtual machine. In addition, the peripheral device determines at least one second VF for data access from the VF set, thus avoiding bandwidth allocation at the virtual machine side, reducing the complexity of data processing of the virtual machine and the processor overhead of the host machine.

It should be noted that the descriptions such as “first” and “second” in the present application are used to distinguish different data, devices, etc., which do not represent the sequence, nor do they limit that “first” and “second” are different types.

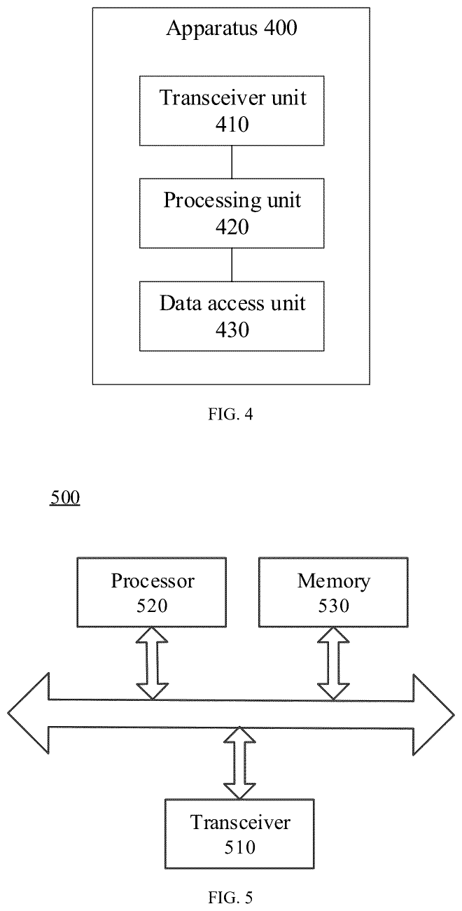

FIG. 4 is a schematic block diagram of an apparatus 400 according to an embodiment of the present application. As shown in FIG. 4, the device 400 may include a transceiver unit 410 and a processing unit 420.

In an implementation, the apparatus 400 may correspond to the peripheral device in the above method embodiment, for example, it may be an implementation of the peripheral device or a component (such as a chip or a chip system) configured in the peripheral device. When the apparatus 400 corresponds to the peripheral device in the above method embodiment, the apparatus 400 may include a transceiver unit 410, a processing unit 420 and a data access unit 430.

The transceiver unit 410 can be configured to receive, through a first VF in the VF set, a data access request sent by the virtual machine, and the data access request is used to request the peripheral device to perform data access to target data in a memory space corresponding to a first data access address; the processing unit 420 can be configured to determine at least one second VF for performing data access from the VF set according to the data access volume of the target data; the data access unit 430 can be configured to perform data access to the target data in the memory space corresponding to the first data access address through the at least one second VF.

In some embodiments, the first VF is configured to simulate a control plane function of the peripheral device.

In some embodiments, the data access unit 430 is specifically configured to: determine at least one second data access address respectively corresponding to the at least one second VF according to the first data access address, where a memory space corresponding to the second data access address is included in the memory space corresponding to the first data access address; and perform data access to the target data in the memory space corresponding to the at least one second data access address through the at least one second VF, respectively.

In some embodiments, the processing unit 420 is specifically configured to: determine, through a device firmware, the at least one second VF for performing the data access from the VF set according to a data access volume of the target data and a data load volume of each VF in the VF set.

In some embodiments, the data access request carries the data access volume.

It should be understood that the specific process of each unit performing the above corresponding steps has been described in detail in the above method embodiment, which will not be repeated here for brevity.

In an implementation, the apparatus 400 may correspond to the host machine in the above method embodiment, for example, it may be an implementation of the host machine, or a component (such as a chip or a chip system) configured in the host machine. When the apparatus 400 corresponds to the host machine in the above method embodiment, the apparatus 400 may include a transceiver unit 410 and a processing unit 420.

The processing unit 420 can be configured to determine a first data access address of target data; the transceiver unit 410 can be configured to send a data access request to a first VF in the VF set through the virtual machine, where the data access request is used for requesting the peripheral device to perform data access to the target data in a memory space corresponding to the first data access address.

In some embodiments, the first VF is configured to simulate a control plane function of the peripheral device. Device information sent by the first VF is obtained through the virtual machine, where the device information is used for determining a data access capability of the VF set.

In some embodiments, the processing unit 420 is further configured to: in a process of data access through at least one second VF, obtain at least one second data access address respectively corresponding to the at least one second VF, where the at least one second VF is determined from the VF set based on a data access volume of the target data, and a memory space corresponding to the second data access address is included in the memory space corresponding to the first data access address, and the second data access address is a guest physical address; for each second VF in the at least one second VF, a second data access address of the second VF is mapped from a guest physical address to a host physical address according to a device page table of the second VF, and the device page table is used for representing a mapping relationship between the guest physical address and the host physical address.

In some embodiments, the processing unit 420 is further configured to: create a device page table of each VF in the VF set through a virtual machine monitor, where the device page table of each VF in the VF set is the same.

In some embodiments, the transceiver unit 410 is further configured to receive an interrupt request sent by the peripheral device through the second VF, where the interrupt request carries an interrupt identification; the processing unit 420 is further configured to determine a virtual machine identification in an interrupt mapping table of the second VF according to the interrupt identification; the processing unit is further configured to control the virtual machine corresponding to the virtual machine identification to interrupt the data access.

In some embodiments, the processing unit 420 is further configured to create an interrupt mapping table corresponding to each VF in the VF set through a virtual machine monitor, where the interrupt mapping table of each VF in the VF set is the same.

In some embodiments, the processing unit 420 is further configured to obtain device information sent by the first VF through the virtual machine, where the device information is used to determine a data access capability of the VF set.

In some embodiments, the processing unit 420 is further configured to designate one VF in the VF set as the first VF through the virtual machine monitor.

It should be understood that the specific process of each unit performing the above corresponding steps has been described in detail in the above method embodiment, which will not be repeated here for brevity.

FIG. 5 is a schematic structural diagram of an electronic device 500 according to an embodiment of the present application. The electronic device 500 shown in FIG. 5 can be implemented as a peripheral device or a host machine, for realizing the steps performed by the peripheral device or the host machine in the above method embodiment. The electronic device 500 includes a processor 520, and the processor 520 can call and run a computer program from a memory to implement the method in the embodiment of the present application.

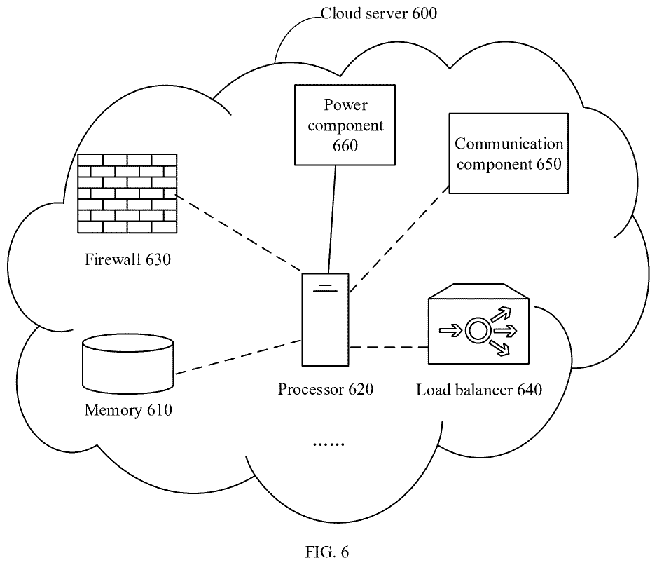

In some embodiments, as shown in FIG. 6, the electronic device 500 may further include a memory 530. The processor 520 can call and run a computer program from the memory 530 to implement the method in the embodiment of the present application.

The memory 530 may be a separate component which is independent of the processor 520 or may be integrated in the processor 520.

In some embodiments, as shown in FIG. 6, the electronic device 500 may further include a transceiver 510, and the processor 520 may control the transceiver 510 to communicate with other devices. Specifically, the transceiver 510 may send information or data to other devices, or receive information or data from other devices.

The transceiver 510 may include a transmitter and a receiver. The transceiver 510 may further include an antenna, and the number of the antenna may be one or more.

In some embodiments, the electronic device 500 can realize the corresponding process of each method of the peripheral device side or the host machine side in the embodiment of the present application, which will not be repeated here for brevity.

FIG. 6 is a structural schematic diagram of a cloud server 600 according to an exemplary embodiment of the present application. The cloud server 600 may be an implementation of the host machine in the above method embodiment. As shown in FIG. 6, the cloud server 600 includes a memory 610 and a processor 620.

The memory 610 is configured to store a computer program and can be configured to store various other data to support operations on the host machine. The memory 610 may be an Object Storage Service (OSS).

The processor 620 is coupled to the memory 610 and is configured to execute the computer program in the memory 610, so as to realize the method implemented by the host machine in the above method embodiment.

Further, as shown in FIG. 6, the cloud server further includes other components such as the firewall 630, the load balancer 640, the communication component 650, the power component 660. Only some components are shown schematically in FIG. 6, which does not mean that the cloud server only includes the components shown in FIG. 6.

It should be understood that the cloud server 600 shown in FIG. 6 can realize various processes related to the host machine in the above method embodiment. The operations and/or functions of each module in the cloud server 600 are respectively used for realizing the corresponding processes in the above method embodiment. For details, reference can be made to the description in the above method embodiment, and detailed description is omitted here to avoid repetition.

The present application further provides a processing device, which includes at least one processor, and the at least one processor is configured to execute a computer program stored in a memory, so that the processing device executes the method executed by the peripheral device or the host machine in the above method embodiment.

The embodiments of the present application further provide a processing device, which includes a processor and an input-output interface. The input-output interface is coupled with the processor. The input-output interface is configured to input and/or output information. The information includes at least one of an instruction or data. The processor is configured to execute a computer program, so that the processing device executes the method executed by the peripheral device or the host machine in the above method embodiment.

The embodiments of the present application further provide a processing device, which includes a processor and a memory. The memory is configured to store a computer program, and the processor is configured to call and run the computer program from the memory, so that the processing device executes the method executed by the peripheral device or the host machine in the above method embodiment.

It should be understood that the processing device can be one or more chips. For example, the processing device may be a field programmable gate array (FPGA), an application specific integrated circuit (ASIC), a system on chip (SoC), a central processor unit (CPU), a network processor (NP), a digital signal processor (DSP), a micro controller unit (MCU), a programmable logic device (PLD) or other integrated chips.

In the process of implementation, the steps of the above method can be completed by hardware integrated logic circuits or software instructions in the processor. The steps of the method disclosed in the embodiment of the present application can be directly embodied as the completion of execution by a hardware processor, or the completion of execution by a combination of hardware and software modules in the processor. The software modules can be located in a mature storage medium in this field such as a random access memory, a flash memory, a read-only memory, a programmable read-only memory or an electrically erasable programmable memory, a register. The storage medium is located in a memory, and the processor reads the information in the memory and combines its hardware to complete the steps of the above method. In order to avoid repetition, it will not be described in detail here.

It should be noted that the processor in the embodiments of the present application can be an integrated circuit chip with a signal processing capability. In the implementation process, the steps of the above method embodiment can be completed by hardware integrated logic circuits or software instructions in the processor. The processor can be a general processor, a digital signal processor (DSP), an application specific integrated circuit (ASIC), a field programmable gate array (FPGA) or other programmable logic devices, discrete gate or transistor logic devices, or discrete hardware components. The method, steps and logic blocks disclosed in the embodiments of the present application can be realized or executed. The general processor can be a microprocessor or the processor can be any conventional processor, etc. The steps of the method disclosed in the embodiment of the present application can be directly embodied as the completion of execution by a hardware decoding processor, or the completion of execution by a combination of hardware and software modules in the decoding processor. The software modules can be located in a mature storage medium in this field such as a random access memory, a flash memory, a read-only memory, a programmable read-only memory or an electrically erasable programmable memory, a register. The storage medium is located in a memory, and the processor reads the information in the memory and combines its hardware to complete the steps of the above method.

It can be understood that the memory in the embodiments of the present application may be a volatile memory or a nonvolatile memory, or may include both volatile and nonvolatile memories. The nonvolatile memory can be a read-only memory (ROM), a programmable read-only memory (programmable ROM, PROM), an erasable programmable read-only memory (erasable PROM, EPROM), an electrically erasable programmable read-only memory (electrically EPROM, EEPROM) or a flash memory. The volatile memory may be a random access memory (RAM) and is used as an external cache. By way of illustration, but not limitation, many forms of RAM are available, such as a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synchlink DRAM, SLDRAM) and a direct rambus random access memory (direct rambus RAM, DR RAM). It should be noted that the memory of the system and the method described in the present application is intended to include, but not limited to, these and any other suitable types of memory.

According to the method provided by the embodiment of the present application, the present application further provides a computer program product, which includes computer program codes which, when run on a computer, causes the computer to execute the method executed by the peripheral device or the host machine in the above method embodiment.

According to the method provided by the embodiment of the present application, the present application further provides a computer-readable storage medium, and the computer-readable storage medium having program codes stored thereon, and when the computer codes are run on a computer, the computer is caused to execute the method executed by the peripheral device or the host machine in the above method embodiment.

The above is only the specific implementation of the present application, but the protection scope of the present application is not limited to this. Any changes or substitutions that can be easily thought of by those familiar with the technical field within the technical scope disclosed in the present application should be included in the protection scope of the present application. Therefore, the protection scope of the present application should be based on the protection scope of the claims.

1. A data access method based on device passthrough of a virtual machine, applied to a peripheral device, wherein a virtual function (VF) set in the peripheral device is device passthrough with a virtual machine in a host machine, the VF set is passthrough into a virtual device in the virtual machine of the host machine, and the method comprises:
receiving, through a first VF in the VF set, a data access request sent by the virtual machine, wherein the data access request is used for requesting the peripheral device to perform data access to target data in a memory space corresponding to a first data access address;
determining at least one second VF for performing data access from the VF set according to a data access volume of the target data; and
performing data access to the target data in the memory space corresponding to the first data access address through the at least one second VF.

2. The method according to claim 1, wherein the first VF is configured to simulate a control plane function of the peripheral device.

3. The method according to claim 1, wherein the performing the data access to the target data in the memory space corresponding to the first data access address through the at least one second VF comprises:
determining, according to the first data access address, at least one second data access address respectively corresponding to the at least one second VF, wherein a memory space corresponding to the second data access address is comprised in the memory space corresponding to the first data access address; and
performing, through the at least one second VF, data access to the target data in a memory space corresponding to the at least one second data access address, respectively.

4. The method according to claim 1, wherein the determining the at least one second VF for performing the data access from the VF set according to the data access volume of the target data comprises:
determining, through a device firmware, the at least one second VF for performing the data access from the VF set, according to the data access volume of the target data and a data load volume of each VF in the VF set.

5. The method according to claim 1, wherein the data access request carries the data access volume.

6. A data access method based on device passthrough of a virtual machine, applied to a host machine, wherein a virtual machine in the host machine is device passthrough with a virtual function (VF) set in a peripheral device, the VF set is passthrough into a virtual device in the virtual machine of the host machine, and the method comprises:
determining a first data access address of target data; and
sending a data access request to a first VF in the VF set through the virtual machine, wherein the data access request is used for requesting the peripheral device to perform data access to the target data in a memory space corresponding to the first data access address.

7. The method according to claim 6, wherein the first VF is configured to simulate a control plane function of the peripheral device, and the method further comprises:
obtaining, through the virtual machine, device information sent by the first VF, wherein the device information is used for determining a data access capability of the VF set.

8. The method according to claim 6, wherein the method further comprises:
in a process of data access through at least one second VF, obtaining at least one second data access address respectively corresponding to the at least one second VF, wherein the at least one second VF is determined from the VF set based on a data access volume of the target data, a memory space corresponding to the second data access address is comprised in the memory space corresponding to the first data access address, and the second data access address is a guest physical address; and
for each second VF in the at least one second VF, mapping the second data access address of the second VF from the guest physical address to a host physical address according to a device page table of the second VF, wherein the device page table is used for representing a mapping relationship between the guest physical address and the host physical address.

9. The method according to claim 8, wherein the method further comprises:
creating a device page table of each VF in the VF set through a virtual machine monitor, wherein the device page table of each VF in the VF set is the same.

10. The method according to claim 8, wherein the method further comprises:
receiving an interrupt request sent by the peripheral device through the second VF, wherein the interrupt request carries an interrupt identification;
determining, according to the interrupt identification, a virtual machine identification in an interrupt mapping table of the second VF; and
controlling a virtual machine corresponding to the virtual machine identification to interrupt data access.

11. The method according to claim 10, wherein the method further comprises:
creating an interrupt mapping table corresponding to each VF in the VF set through a virtual machine monitor, wherein the interrupt mapping table of each VF in the VF set is the same.

12. The method according to claim 6, wherein the method further comprises:
designating a VF in the VF set as the first VF through a virtual machine monitor.

13. An electronic device comprising: at least one processor and a memory;
wherein the memory stores computer-executable instructions; and
the at least one processor executes the computer-executable instructions stored in the memory, so that the at least one processor performs the method according to claim 1.

14. A device passthrough system, comprising: a peripheral device and a host machine;
wherein a virtual function (VF) set in the peripheral device is device passthrough with a virtual machine of the host machine, and the VF set is passthrough into a virtual device in the virtual machine of the host machine;
wherein the host machine is configured to send a data access request to a first VF in the VF set through the virtual machine, and the data access request is used for requesting the peripheral device to perform data access to target data in a memory space corresponding to a first data access address;
the peripheral device is configured to receive, through the first VF in the VF set, the data access request sent by the virtual machine.

15. The method according to claim 2, wherein the performing the data access to the target data in the memory space corresponding to the first data access address through the at least one second VF comprises:
determining, according to the first data access address, at least one second data access address respectively corresponding to the at least one second VF, wherein a memory space corresponding to the second data access address is comprised in the memory space corresponding to the first data access address; and
performing, through the at least one second VF, data access to the target data in a memory space corresponding to the at least one second data access address, respectively.

16. The method according to claim 2, wherein the determining the at least one second VF for performing the data access from the VF set according to the data access volume of the target data comprises:
determining, through a device firmware, the at least one second VF for performing the data access from the VF set, according to the data access volume of the target data and a data load volume of each VF in the VF set.

17. The method according to claim 2, wherein the data access request carries the data access volume.

18. The method according to claim 7, wherein the method further comprises:
in a process of data access through at least one second VF, obtaining at least one second data access address respectively corresponding to the at least one second VF, wherein the at least one second VF is determined from the VF set based on a data access volume of the target data, a memory space corresponding to the second data access address is comprised in the memory space corresponding to the first data access address, and the second data access address is a guest physical address; and
for each second VF in the at least one second VF, mapping the second data access address of the second VF from the guest physical address to a host physical address according to a device page table of the second VF, wherein the device page table is used for representing a mapping relationship between the guest physical address and the host physical address.

19. The method according to claim 7, wherein the method further comprises:
designating a VF in the VF set as the first VF through a virtual machine monitor.

20. An electronic device comprising: at least one processor and a memory;
wherein the memory stores computer-executable instructions; and
the at least one processor executes the computer-executable instructions stored in the memory, so that the at least one processor performs the method according to claim 6.
